(19) United States
(12) Patent Application Publication
(10) Pub. No.: US 2026/0146658 A1
(43) Pub. Date: May 28, 2026

(54) DISC BRAKE ADAPTOR ASSEMBLY

(71) Applicant: 2360216 Ontario Inc., Mississauga (CA)

(72) Inventor: Mats LIPOWSKI, Mississauga (CA)

(21) Appl. No.: 19/130,420

(22) PCT Filed: Nov. 14, 2024
(86) PCT No.: PCT/CA2023/051526

§ 371 Date: May 15, 2025

Related U.S. Application Data
(60) Provisional application No. 63/425,675, filed on Nov. 15, 2022.

(51) Int. Cl. F16D 65/12; B60B 27/02; F16D 65/02

(52) U.S. Cl. CPC F16D 65/123; B60B 27/023; F16D 2065/1384; F16D 2065/1392

(57) ABSTRACT

A disc brake rotor adaptor for bicycle hub is described. The adaptor includes an adaptor ring and a collet ring. The adaptor ring includes a plurality of holes extending through the adaptor ring, the holes configured to align with corresponding holes in a disc brake rotor. A first face shaped to interface with the disc brake rotor. A plurality of teeth are positioned on the inner circumferential surface of the adaptor ring proximal the first face. A second face includes an inner circumferential recess. The collet ring includes a body and a plurality of posts extending there from. The posts are configured to align with the holes extending through the adaptor ring. The collet ring is shaped to nest within the inner circumferential recess of the second face of the adaptor ring.

This application claims priority to U.S. Patent Application No. 63/425,675 filed Nov. 15, 2022, titled “DISC BRAKE ADAPTOR ASSEMBLY”. The application relates generally to an adaptor assembly for bicycles and specifically to a disc brake adaptor assembly to facilitate use of a centre-lock wheel bicycle hub with a six-bolt disc brake rotor.

### BACKGROUND

Cycling has gained widespread acceptance not only as a means of transportation but also as a form of recreation. As a result, the bicycle industry is constantly making improvements to various bicycle parts. Bicycle braking systems in particular have undergone wide-ranging redesigns over the past few years.

Several types of bicycle braking devices are available on the market, including rim brakes, caliper brakes, disc brakes, and other general bicycle braking devices. Disc brake systems are often the braking systems of choice when the rider requires a very high-performance braking system. That is because disc brake systems confer a very large amount of control relative to the force of operation applied to the brake lever, and they generally are very robust under carrying weather or riding conditions.

Disc brake systems normally comprise a caliper connected to the bicycle frame, a brake lever attached to the bicycle handlebar for operating the caliper, and a disc brake rotor securely connected to the bicycle wheel hub. Examples of disc brake rotors include the six-bolt rotor and the centerlock rotor. Each rotor connects a corresponding bicycle wheel hub. However, it is often desirable to use a centerlock bicycle hub with six-bolt rotor. Accordingly, adapters have been developed to facilitate such functionality.

In a common implementations, the adaptor attaches the disc brake rotor to the wheel hub, and a fastener, in the form of a lock ring, is screwed onto the bicycle wheel hub in order to secure the disc brake rotor assembly in place. Examples of such adaptors are known in the art and described in U.S. Pat. No. 7,665,584 to Hirotomi et al. and U.S. Pat. No. 7,143,872 to Takizawa.

However, the lock ring requires use of a specialized tool for fastening. Accordingly, it is desirable to provide a disc brake rotor adaptor assembly that obviates or mitigates at least this disadvantage.

### SUMMARY

In accordance with an aspect of an embodiment a disc brake rotor adaptor for bicycle hub is described. The adaptor includes an adaptor ring and a collet ring. The adaptor ring includes a plurality of holes extending through the adaptor ring, the holes configured to align with corresponding holes in a disc brake rotor. A first face shaped to interface with the disc brake rotor. A plurality of teeth are positioned on the inner circumferential surface of the adaptor ring proximal the first face. A second face includes an inner circumferential recess. The collet ring includes a body and a plurality of posts extending there from. The posts are configured to align with the holes extending through the adaptor ring. The collet ring is shaped to nest within the inner circumferential recess of the second face of the adaptor ring.

The inner circumference of the collet ring may be sized to snugly fit within a groove of the bicycle hub. The collet ring may include includes a discontinuity. The collet ring may include a plurality of pieces configured to be coupled together when assembling the adaptor. The adaptor ring may further include a plurality of radially extending projections and the plurality of holes extend through respective ones of the projections. The collet ring may include a material with a high elastic limit. The plurality of posts may be internally threaded to receive the securing bolts. The bicycle hub may be a centerlock wheel hub and the rotor may be a six-bolt rotor.

The plurality of posts may be cylindrical. The plurality of holes extending through the adaptor ring may be cylindrically shaped to mate with the posts.

At least one of the posts may include a cylindrical shaped portion and a non-cylindrical shaped portion. The cylindrical shaped portion may be proximal the body of the collet ring and the non-cylindrical shaped portion may be distal from the body of the collet ring. At least one of the plurality of holes extending through the adaptor ring may include a cylindrical shaped portion proximal the first face configured to mate with the cylindrical shaped portion of the post and a non-cylindrical shaped portion proximal the second face configured to mate with the non-cylindrical shaped portion of the post.

In some embodiments, all of the posts may include the cylindrical shaped portion and the non-cylindrical shaped portion. All of the plurality of holes extending through the adaptor ring may include a cylindrical shaped portion proximal the first face configured to mate with the cylindrical shaped portion of the posts and a non-cylindrical shaped portion proximal the second face configured to mate with the non-cylindrical shaped portion of the post. The non-cylindrical shaped portion may be an oval shaped portion.

### BRIEF DESCRIPTION OF THE DRAWINGS

Embodiments of the invention will now be described by way of example only with reference to the following drawings in which:

FIG. 1a is a side view of a centrelock bicycle hub (prior art);

FIG. 1b is an enlarged view of section A illustrated in FIG. 1a (prior art);

FIG. 2 is an exploded view of an adaptor in accordance with an aspect of an embodiment;

FIG. 3a is a front view of an adaptor ring;

FIG. 3b is a side of the adaptor ring;

FIG. 3c is a front isometric view of the adaptor ring;

FIG. 3d is a rear isometric view of the adaptor ring;

FIG. 3e is a rear view of the adaptor ring;

FIG. 4a is a front view of a collet ring;

FIG. 4b is a side of the collet ring;

FIG. 4c is a front isometric view of the collet ring;

FIG. 5a is a front view of an adaptor ring in accordance with another aspect of an embodiment;

FIG. 5b is a side of the adaptor ring;

FIG. 5c is a front isometric view of the adaptor ring;

FIG. 5d is a rear isometric view of the adaptor ring;

FIG. 5e is a rear view of the adaptor ring;

FIG. 6a is a front view of a collet ring in accordance with another aspect of an embodiment;

FIG. 6b is a side of the collet ring; and

FIG. 6c is a front isometric view of the collet ring.

### DETAILED DESCRIPTION OF THE PREFERRED EMBODIMENTS

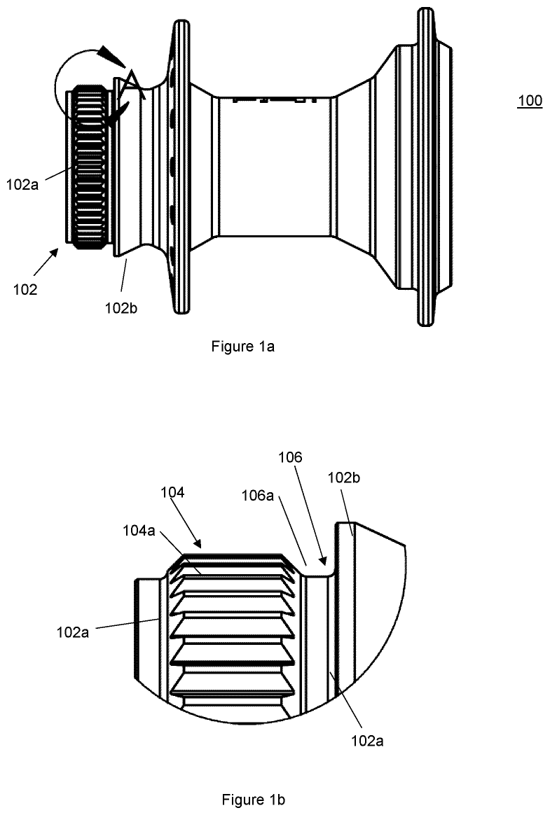

For convenience, like numerals in the description refer to like structures in the drawings. Referring to FIGS. 1a and 1b, an example of a prior art centrelock bicycle hub is illustrated generally by numeral 100. The centrelock bicycle hub 100 a rotor end 102 configured for coupling to a rotor (not shown). The rotor end 102 of the centrelock bicycle hub 100 includes a tubular member 102a, an annular flange 102b, and a mounting spline 104. The annular flange 102b extends radially outward from the tubular member 102a. The mounting spline 104 stands proud of the tubular member 102a. In some embodiments, the mounting spline 104 has an outer peripheral surface defining a plurality of teeth 104a. Between the mounting spline 104 and the annular flange 102b is groove 106. The mounting spline 104 has a flared surface 106a that flares out of the groove 106.

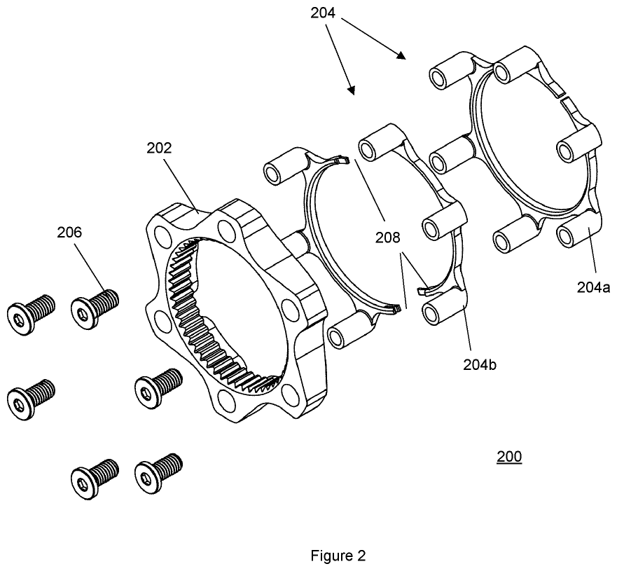

Referring to FIG. 2, an exploded view of an adaptor assembly in accordance with some embodiments is illustrated generally by numeral 200. The adaptor assembly 200 includes an adaptor ring 202, a collet ring 204. A plurality of securing bolts 206 can be used to secure the rotor (not shown) to the adaptor assembly 200, once the adaptor assembly 200 is in place. In some embodiments, the collet ring 204 is a one-piece collet ring 204a. In some embodiments, the collet ring 204 is a multi-piece collet ring 204b. The multi-piece collet ring 204b illustrated in FIG. 2 is a two-piece collet ring 204b. The two-piece collet ring 204b may include connectors 208 to couple the pieces of the two-piece collet ring 204b together. For example, in some embodiments the connectors 208 are tongue and groove type connectors.

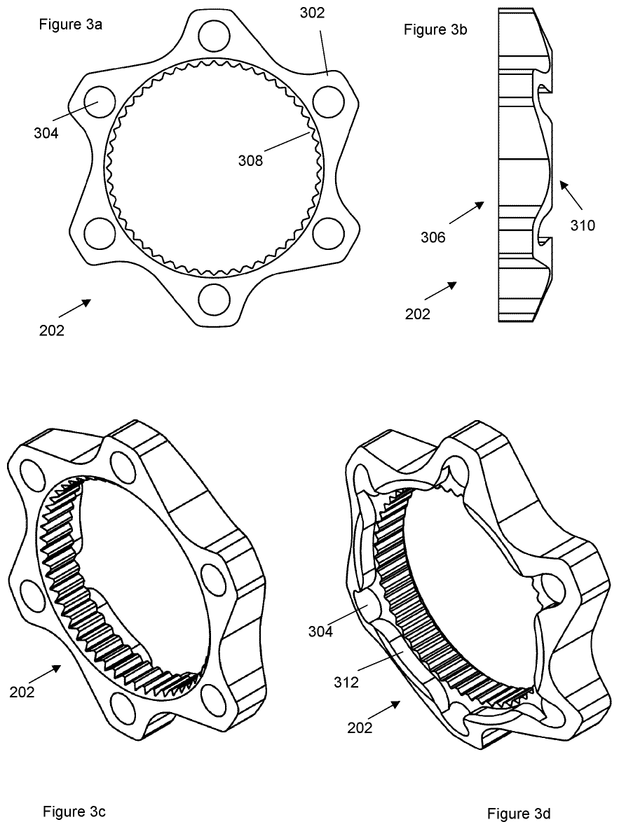

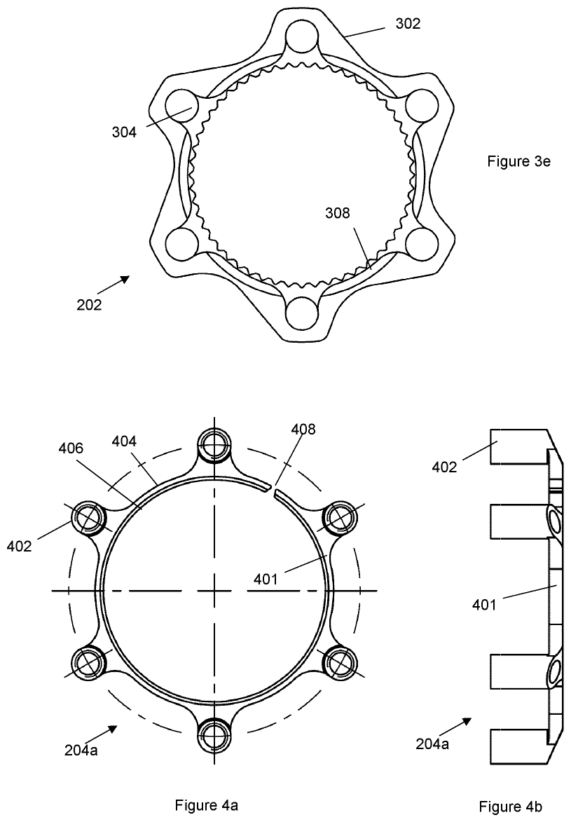

Referring to FIGS. 3a to 3e, the adaptor ring 202 is shown in greater detail. The adaptor ring 202 has a plurality of projections 302 extending radially therefrom. In some embodiments, the projections 302 are fin-shaped. In some embodiments, each projection 302 includes a hole 304 extending there through. Each of the projections 302 is shaped and positioned so that the holes 304 will be aligned with corresponding holes in the rotor.

A first face 306 of the adaptor ring 202 is shaped to interface with the rotor (not shown). In some embodiments, the first face 306 is flat. Further, at least a portion of the inner circumferential surface of the adaptor ring 202 proximal the first face 306 is splined to include a plurality of teeth 308. The teeth 308 of the adaptor ring 202 are configured to mate with the teeth 104a of the centrelock bicycle hub 100.

A second face 310 of the adaptor ring 202 is shaped to interface with the collet ring 204. In some embodiment, the first face 306 and the second face 310 are on opposing sides of the adaptor ring 202. In some embodiments, at least a portion of the inner circumference of the adaptor ring 202 proximal the second face 310 is not splined but shaped to receive the collet ring 204. Specifically, the second face 310 includes an inner circumferential recess 312 shaped to receive the collet ring 204, as illustrated in FIGS. 3d and 3e.

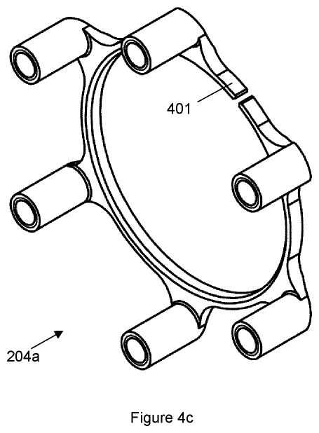

Referring to FIGS. 4a to 4c, an example embodiment of the one-piece collet ring 204a is shown in greater detail. The one-piece collet ring 204a is made of a material having a high elastic limit. Example materials include steel, aluminum, Bulk Metallic Glasses (BMGs), also known as amorphous metals, and the like. The one-piece collet ring 204a includes a substantially circular body 401 and a plurality of posts 402 protruding there from. Each of the posts 402 is positioned about the body 401 of the one-piece collet ring 204a so that they can be received in corresponding ones of the holes 304 of the adaptor ring 202. Each of the posts 402 is internally threaded to mate with the securing bolts 206, which are also threaded. The outer circumference 404 of the body 401 of the one-piece collet ring 204a is sized so it fits within the inner circumferential recess 312 of the adaptor ring 202. The inner circumferential surface 406 of the body of the one-piece collet ring 204a is sized to snugly fit about the centrelock bicycle hub 100 within the groove 106. The body 401 one-piece collet ring 204a includes a discontinuity 408. The discontinuity 408 allows the one-piece collet ring 204a to be opened so that it can be placed into the groove 106 of the centrelock bicycle hub 100. Thus, the one-piece collet ring 204a requires sufficient elasticity to facilitate it being placed into the groove 106.

Alternatively, if the two-piece collet ring 204b is used, each piece can be placed into the groove 106 of the centrelock bicycle hub 100. The pieces of the two-piece collet ring 204b can be coupled by the connectors 208 to hold the two-piece collet ring 204b in place once is has been placed into the groove 106 of the centrelock bicycle hub 100. Since the two-piece collet ring 204b does not need to be deformed to be placed in the groove 106, in some embodiments it can be made using a less elastic material than the one-piece collet ring 204a.

The collet ring 204 (either the one-piece collet ring 204a or the two-piece collet ring 204b) can mate with the adaptor ring 202. Specifically, the collet ring 204 can be received by the inner circumferential recess 312 of the adaptor ring 202. Further, the posts 402 of the collet ring 204 can be received by the holes 304 of the adaptor ring 202. Thus, the adaptor ring 202 maintains the generally circular shape of the collet ring 204.

An example of connecting a six-bolt rotor to the centrelock bicycle hub 100 is described as follows. The collet ring 204 is placed into the groove 106 of the centrelock bicycle hub 100, as described above. The adaptor ring 202 is placed onto the centrelock bicycle hub 100 so that its teeth 308 mate with the teeth 104a of the centrelock bicycle hub 100. The collet ring 204 can be rotated as necessary until the posts 402 are aligned with the holes 304 of the adaptor ring 202. The collet ring 204 and the adaptor ring 202 are mated together so that the collet ring 204 nests within the inner circumferential recess 312 of the adaptor ring 202. The rotor is aligned with the adaptor ring 202 so that holes in the rotor are aligned with the holes 304 in the adaptor ring 202. The securing bolts 206 are passed through the holes in rotor and the holes 304 in the adaptor ring 202, and are threaded into the posts 402 of the collet ring 204. As the securing bolts 206 are threaded, the rotor, the adaptor ring 202, and the collet ring 204 are brought together. This action forces the inner circumferential surface 406 of the collet ring 204 against the flared surface 106a of the centrelock bicycle hub 100, thereby securing the adaptor assembly 200 in place.

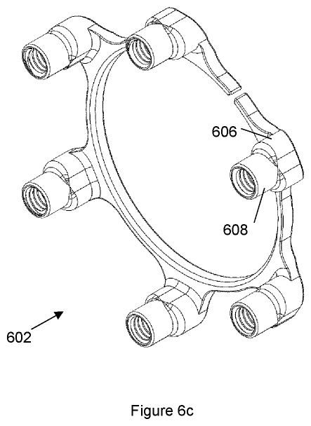

In some embodiments, the posts 402 of the collet ring 204 are cylindrical shaped. In some embodiments, other shapes may be used. For example, referring to FIGS. 6a to 6c, another example embodiment of a one-piece collet ring 602 is shown in greater detail. The one-piece collet ring 602 includes a body 603 and a plurality of posts 604 protruding there from. Each post 604 includes an oval shaped portion 606 and a cylindrical shaped portion 608. The oval shaped portion 606 is located at the base of the post 604, proximal the body 603 of the collet ring 602. The cylindrical shaped portion 608 is located distal from the body 603 of the collet ring 602. The posts 604 are positioned about the body 603 of the one-piece collet ring 602.

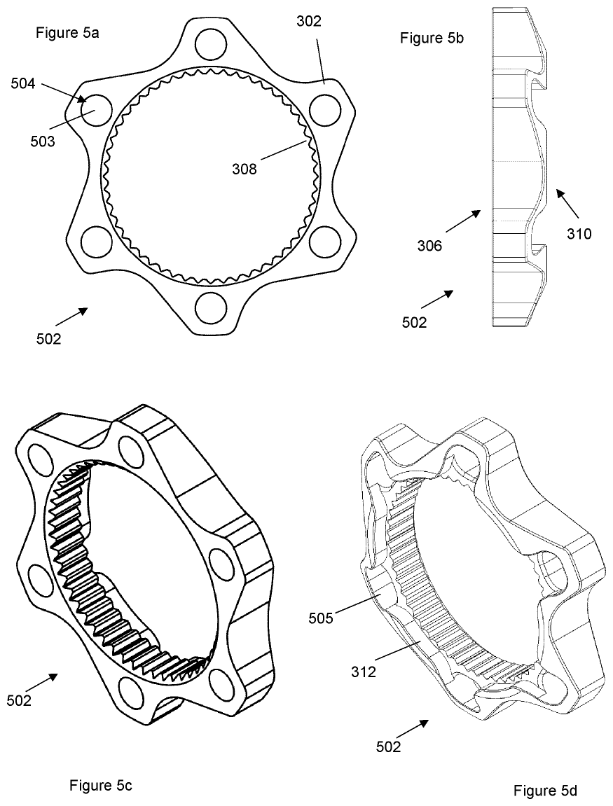

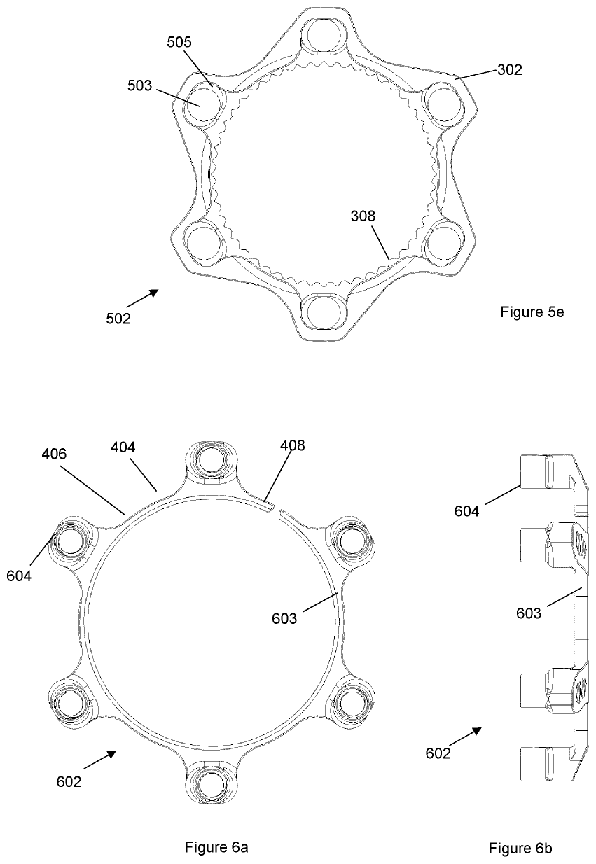

Referring to FIGS. 5a to 5e, an example embodiment of an adaptor ring adapted to receive the collet ring 602 is illustrated generally by numeral 502. The adaptor ring 502 has a plurality of projections 302 extending radially therefrom. In some embodiments, each projection 302 includes a hole 504 extending there through. Each of the projections 302 is shaped and positioned so that the holes 504 will be aligned with corresponding holes in the rotor.

A first face 506 of the adaptor ring 202 is shaped to interface with the rotor (not shown). In some embodiments, the first face 306 is flat. A portion 503 of the hole 504 proximal the first face 506 is cylindrically shaped to mate with the cylindrical shaped portion 608 of the posts 604 of the collet ring 602. A second face 510 of the adaptor ring 502 is shaped to interface with the collet ring 602. In some embodiment, the first face 506 and the second face 510 are on opposing sides of the adaptor ring 202. A portion 505 of the hole 504 proximal the second face 510 is oval shaped to mate with the oval shaped portion 606 of the posts 604 of the collet ring 602.

In some embodiments, only some posts 604 include an oval shaped portion 606 and a cylindrical shaped portion 608. In some embodiments, only one of the posts 604 includes an oval shaped portion 606 and a cylindrical shaped portion 608. In some embodiments, a multi-piece collet ring includes posts 604 having the oval shaped portion 606 and the cylindrical portion 608 described above.

The oval shaped portion 606 of the posts 604 inhibits rotation of the posts 604 when the posts 604 are nested within the adaptor ring 502. Inhibiting rotation of the posts 604 reduces the likelihood of the posts 604 shearing when excessive torque is applied to the securing bolts 206.

Although the adaptor assembly 200 has been described with reference to specific embodiments, the claims should not be limited by them. For example, although the posts 604 are described as having an oval shaped portion, other non-cylindrical shaped portions may be used. For example, the posts 604 may include a rectangular shaped portion instead of the oval shaped portion. Thus, the scope of the claims should not be limited by the preferred embodiments described in the examples but should be given the broadest interpretation consistent with the description as a whole.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Also, the use of “a” or “an” is employed to describe elements and components described herein. This is done merely for convenience and to give a general sense of the scope of the invention. This description should be read to include one or at least one and the singular also includes the plural unless it states otherwise.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

1. A disc brake rotor adaptor for bicycle hub, the adaptor comprising:
an adaptor ring comprising:
a plurality of holes extending through the adaptor ring, the holes configured to align with corresponding holes in a disc brake rotor;
a first face shaped to interface with the disc brake rotor;
a plurality of teeth are positioned on the inner circumferential surface of the adaptor ring proximal the first face; and
a second face comprising an inner circumferential recess; and
a collet ring comprising a body and a plurality of posts extending there from; the posts configured to align with the holes extending through the adaptor ring, wherein the collet ring is shaped to nest within the inner circumferential recess of the second face of the adaptor ring.

2. The disc brake rotor adaptor of claim 1, wherein the inner circumference of the collet ring is sized to snugly fit within a groove of the bicycle hub.

3. The disc brake rotor adaptor of claim 1, wherein the collet ring includes a discontinuity.

4. The disc brake rotor adaptor of claim 1, wherein the collet ring comprises a plurality of pieces configured to be coupled together when assembling the adaptor.

5. The disc brake rotor adaptor of claim 1, wherein the adaptor ring further comprises a plurality of radially extending projections and the plurality of holes extend through respective ones of the projections.

6. The disc brake rotor adaptor of claim 1, wherein the collet ring comprises a material with a high elastic limit.

7. The disc brake rotor adaptor of claim 1, wherein the plurality of posts are internally threaded to receive securing bolts.

8. The disc brake rotor adaptor of claim 1, wherein the bicycle hub is a centerlock wheel hub and the disc brake rotor is a six-bolt rotor.

9. The disc brake rotor adaptor of claim 1, wherein the plurality of posts are cylindrical.

10. The disc brake rotor adaptor of claim 9, wherein the plurality of holes extending through the adaptor ring are cylindrically shaped to mate with the posts.

11. The disc brake rotor adaptor of claim 1, wherein at least one of the posts comprises a cylindrical shaped portion and a non-cylindrical shaped portion.

12. The disc brake rotor adaptor of claim 11, wherein the cylindrical shaped portion is proximal the body of the collet ring and the non-cylindrical shaped portion is distal from the body of the collet ring.

13. The disc brake rotor adaptor of claim 12, wherein at least one of the plurality of holes extending through the adaptor ring comprises a cylindrical shaped portion proximal the first face configured to mate with the cylindrical shaped portion of the post and a non-cylindrical shaped portion proximal the second face configured to mate with the non-cylindrical shaped portion of the post.

14. The disc brake rotor adaptor of claim 12, wherein all of the posts comprise the cylindrical shaped portion and the non-cylindrical shaped portion.

15. The disc brake rotor adaptor of claim 14, wherein all of the plurality of holes extending through the adaptor ring comprise a cylindrical shaped portion proximal the first face configured to mate with the cylindrical shaped portion of the posts and a non-cylindrical shaped portion proximal the second face configured to mate with the non-cylindrical shaped portion of the post.

16. The disc brake rotor adaptor of claim 11, wherein the non-cylindrical shaped portion is an oval shaped portion.
